(19) United States
(12) Patent Application Publication
(10) Pub. No.: US 2025/0309403 A1
(43) Pub. Date: Oct. 2, 2025

(54) TAB COOLING STRUCTURE AND TAB COOLING STRUCTURE ASSEMBLY

(71) Applicant: HONDA MOTOR CO., LTD., Tokyo (JP)

(72) Inventors: Nobuyuki AKAISHI, Saitama (JP); Daichi WATANABE, Saitama (JP); Takahiro YASUE, Saitama (JP)

(21) Appl. No.: 19/063,101

(22) Filed: Feb. 25, 2025

(30) Foreign Application Priority Data
Mar. 27, 2024 (JP) 2024-052429

(51) Int. Cl. H01M 10/6556; H01M 10/613; H01M 10/658; H01M 50/293; H01M 50/536

(52) U.S. Cl. CPC H01M 10/6556; H01M 10/613; H01M 10/658; H01M 50/536; H01M 50/293

(57) ABSTRACT

A tab cooling structure cools a tab of one of battery cells. The tab cooling structure includes first and second coolers, first and second supply pipes, and first and second discharge pipes. The first cooler is positioned further toward one side in the X direction than the tab to be cooled. The second cooler is positioned further toward an opposite side in the X direction than the tab to be cooled. A refrigerant is supplied to the first cooler through the first supply pipe. The refrigerant is supplied to the second cooler through the second supply pipe. The refrigerant is discharged from the first cooler through the first discharge pipe. The refrigerant is discharged from the second cooler through the second discharge pipe. The first cooler and the second cooler sandwich the tab to be cooled therebetween in the X direction.

This application is based on and claims the benefit of priority from Japanese Patent Application No. 2024-052429, filed on 27 Mar. 2024, the content of which is incorporated herein by reference.

### BACKGROUND OF THE INVENTION

### Field of the Invention

The present invention relates to structures for cooling tabs of battery cells and an assembly of the structures connected together.

### Related Art

In recent years, the popularity of electrically powered vehicles such as electric vehicles (EVs) and hybrid electric vehicles (HEVs) has been increasing from the perspective of reducing carbon dioxide emissions and mitigating negative impacts on the global environment, for example. Some batteries that are mounted in electrically powered vehicles, for example, include a plurality of battery cells. The battery cells are stacked in an X direction, and each have a cell body and tabs that protrude from the cell body in a Y direction.

Patent Document 1: Japanese Unexamined Patent Application, Publication No. 2023-148244

### SUMMARY OF THE INVENTION

The inventors of the present invention have taken note of the following issues associated with batteries such as described above. The tab temperature rises, for example, in fast battery charging and in battery discharging during high-load driving. Once the tab temperature reaches the limit of the allowable range thereof, it is necessary to reduce the current to prevent the tab temperature from rising further. As such, the tab temperature can be a rate-limiting factor in fast battery charging and in battery discharging during high-load driving.

Specifically, in a situation where the tab temperature reaches the limit of the allowable range thereof before the temperature of any part of the cell body reaches the limit of the allowable range thereof, the tab temperature serves as a rate-limiting factor in fast battery charging and in battery discharging during high-load driving.

The present invention was made in view of the foregoing circumstances, and an object thereof is to reduce an increase in tab temperature in fast battery charging and in battery discharging during high-load driving.

The inventors found that providing a specific cooling structure for a tab allows for achieving the object of the present invention, and thus arrived at the present invention. The present invention is directed to a tab cooling structure described in (1) to (8) below and a tab cooling structure assembly described in (9) and (10) below.
(1) A tab cooling structure for cooling a tab of one of battery cells stacked in a predetermined X direction, each of the battery cells including a cell body and the tab protruding from the cell body in a Y direction orthogonal to the X direction, the tab cooling structure including:
   a first cooler that is positioned further toward one side in the X direction than the tab to be cooled;
   a second cooler that is positioned further toward an opposite side in the X direction than the tab to be cooled;
   a first supply pipe through which a refrigerant is supplied to the first cooler;
   a second supply pipe through which the refrigerant is supplied to the second cooler;
   a first discharge pipe through which the refrigerant is discharged from the first cooler; and
   a second discharge pipe through which the refrigerant is discharged from the second cooler, wherein
   the first cooler and the second cooler sandwich the tab to be cooled therebetween in the X direction.

According to this configuration, it is possible to cool the tab using the first cooler and the second cooler. The configuration therefore makes it possible to reduce an increase in the temperature of the tabs in fast battery charging and in battery discharging during high-load driving. As a result, it is possible to prevent the temperature of the tabs from serving as a rate-limiting factor in fast battery charging and in battery discharging during high-load driving.
(2) The tab cooling structure described in (1), wherein the first cooler and the second cooler sandwich a portion of the cell body therebetween in the X direction.

According to this configuration, it is possible to cool a portion of the cell body as well as the tab. As a result, it is possible to prevent the temperature of such portions of the cell bodies, as well as the temperature of the tabs, from serving as a rate-limiting factor in fast battery charging and in battery discharging during high-load driving.
(3) The tab cooling structure described in (2), wherein the cell body includes, at an end thereof in the Y direction, a tab joint that electrically connects a predetermined electrode body and the tab, and a protrusion that covers at least a portion of the tab joint and a portion of the tab, the protrusion being an insulator, and
   the first cooler and the second cooler sandwich the protrusion therebetween in the X direction, thereby sandwiching at least a portion of the tab joint and at least a portion of the tab therebetween in the X direction.

According to this configuration, it is possible to cool the tab joint as well as the tab. As a result, it is possible to prevent the temperature of the tab joints, as well as the temperature of the tabs, from serving as a rate-limiting factor in fast battery charging and in battery discharging during high-load driving.
(4) The tab cooling structure described in any one of (1) to (3), including:
   a first unit including a first body, the first supply pipe, the first cooler, and the first discharge pipe, the first body containing the first supply pipe, the first cooler, and the first discharge pipe; and
   a second unit including a second body, the second supply pipe, the second cooler, and the second discharge pipe, the second body containing the second supply pipe, the second cooler, and the second discharge pipe.

According to this configuration, the first body allows the first supply pipe, the first cooler, and the first discharge pipe to be integrated into a unitized structure. Furthermore, the second body allows the second supply pipe, the second cooler, and the second discharge pipe to be integrated into a unitized structure. The configuration described above makes it possible to simplify the overall design of the tab cooling structure.
(5) The tab cooling structure described in (4), wherein a lengthwise middle portion of the first unit and a lengthwise middle portion of the second unit are movable relative to each other in the X direction, and
   the tab is inserted between the lengthwise middle portion of the first unit and the lengthwise middle portion of the second unit.

According to this configuration, it is possible to easily insert the tab between the lengthwise middle portion of the first unit and the lengthwise middle portion of the second unit.
(6) The tab cooling structure described in (4), wherein
   the first body has a first engagement portion,
   the second body has a second engagement portion,
   the first unit and the second unit are engaged with each other through engagement of the first engagement portion and the second engagement portion with each other, and
   the tab is placed between the first unit and the second unit.

According to this configuration, it is possible to easily place the tab between the first unit and the second unit by engaging the first engagement portion and the second engagement portion with each other.
(7) The tab cooling structure described in any one of (1) to (6), wherein
   the refrigerant is supplied from the first supply pipe to a lower portion of the first cooler and is discharged from an upper portion of the first cooler to the first discharge pipe, thereby flowing from bottom to top inside the first cooler, and
   the refrigerant is supplied from the second supply pipe to a lower portion of the second cooler and is discharged from an upper portion of the second cooler to the second discharge pipe, thereby flowing from bottom to top inside the second cooler.

According to this configuration, it is possible to discharge only excess refrigerant from the upper portion of the first cooler while filling the first cooler with the refrigerant from the lower portion. Such a mechanism makes it possible to prevent air from easily entering the first cooler. The same mechanism applies to the second cooler, making it possible to prevent air from easily entering the second cooler.
(8) The tab cooling structure described in any one of (1) to (7), wherein each of the battery cells is an all-solid-state battery having a solid electrolyte layer therein.

The operating temperature range of all-solid-state batteries is relatively wide. In the configuration in which the battery cells are all-solid-state batteries, therefore, the temperature of the tabs easily reaches the limit of the allowable range thereof before the temperature of any part of the cell bodies reaches the limit of the allowable range thereof. The temperature of the tabs therefore tends to be a rate-limiting factor in fast battery charging and in battery discharging during high-load driving. The effect of reducing increase in the temperature of the tabs in fast battery charging and in battery discharging during high-load driving produced by the tab cooling structure described in (1) is therefore more significant in this configuration than in other configurations.
(9) A tab cooling structure assembly including a plurality of the tab cooling structures described in any one of (1) to (8), the tab cooling structures being arranged in the X direction, wherein
the tab cooling structures located next to each other in the X direction are connected together, and
the plurality of tab cooling structures cool the tabs of the battery cells.

According to this configuration, it is possible to cool each of the tabs of the plurality of battery cells. Furthermore, as a result of connecting the tab cooling structures located next to each other in the X direction, it is possible to prevent each battery cell from being displaced in the X direction.
(10) The tab cooling structure assembly described in (9), further including:
   one or more first supply pipe connectors that connect the first supply pipes in the tab cooling structures located next to each other in the X direction;
   one or more second supply pipe connectors that connect the second supply pipes in the tab cooling structures located next to each other in the X direction;
   one or more first discharge pipe connectors that connect the first discharge pipes in the tab cooling structures located next to each other in the X direction; and
   one or more second discharge pipe connectors that connect the second discharge pipes in the tab cooling structures located next to each other in the X direction.

According to this configuration, as a result of connecting the first supply pipes together, it is possible to efficiently supply the refrigerant to each of the plurality of first coolers. Likewise, as a result of connecting the second supply pipes together, it is possible to efficiently supply the refrigerant to each of the plurality of second coolers. As a result of connecting the first discharge pipes together, it is possible to efficiently discharge the refrigerant from each of the plurality of first coolers. Likewise, as a result of connecting the second discharge pipes together, it is possible to efficiently discharge the refrigerant from each of the plurality of second coolers. The configuration in which the pipes are connected as described above permits adjustment of the number of tab cooling structures to be connected according to the number of battery cells to be stacked, making it easy to accommodate differences in the number of cells to be stacked. The tab cooling structure assembly is therefore highly versatile.

As described above, the configuration described in (1) makes it possible to reduce an increase in the temperature of the tabs in fast battery charging and in battery discharging during high-load driving. Furthermore, the configurations described in (2) to (10) referring to (1) each produce an additional effect.

### BRIEF DESCRIPTION OF THE DRAWINGS

FIG. 1 is a perspective view illustrating a tab cooling structure assembly according to a first embodiment and an area therearound;

FIG. 2 is an exploded perspective view illustrating the tab cooling structure assembly and an area therearound;

FIG. 3 is a perspective view of a tab cooling structure;

FIG. 4 is a perspective view illustrating first and second units on the left side, and the inside thereof on the right side;

FIG. 5 is a perspective view illustrating the tab cooling structure assembly shown in FIG. 1 by omitting first and second bodies;

FIG. 6 is a side view illustrating the tab cooling structure and an area therearound;

FIG. 7 is a side view illustrating a tab to which the tab cooling structure is attached and an area therearound;

FIG. 8 is a schematic diagram illustrating an example of a cooling circuit;

FIG. 9 is a schematic diagram illustrating another example of the cooling circuit; and

FIG. 10 is an exploded perspective view illustrating a tab cooling structure according to a second embodiment.

### DETAILED DESCRIPTION OF THE INVENTION

The following describes embodiments of the present invention with reference to the accompanying drawings. However, the present invention is not in any way limited to the following embodiments, and appropriate modifications can be made within the scope of the gist of the present invention to practice the present invention.

### First Embodiment

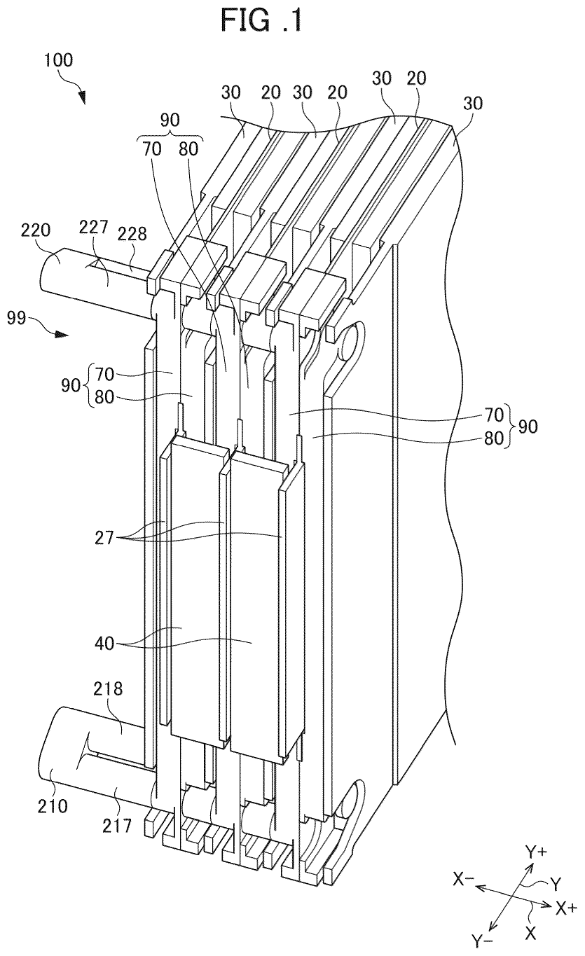

A first embodiment relates to a technique for cooling a portion of a battery 100 shown in FIG. 1. Hereinafter, two predetermined directions that are orthogonal to each other in a horizontal plane are referred to as “X direction” and “Y direction”. One side in the X direction is referred to as “X− side” and a side opposite thereto is referred to as “X+ side”. One side in the Y direction is referred to as “Y− side” and a side opposite thereto is referred to as “Y+ side”.

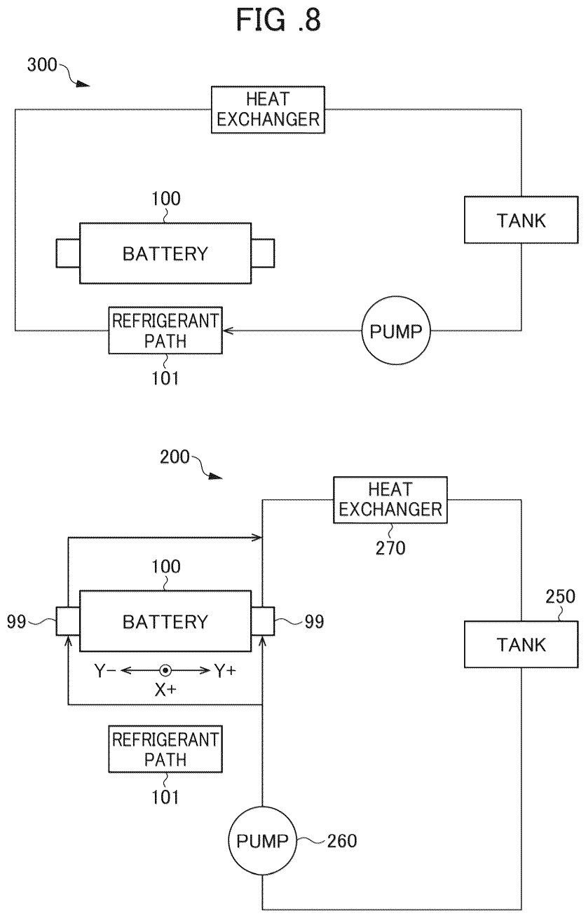

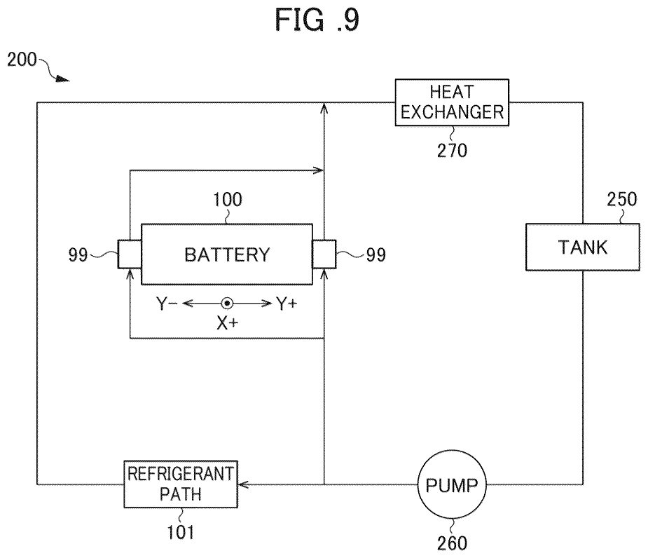

The battery 100 shown in FIG. 1 includes a plurality of battery cells 20, a plurality of Y− side tab cooling structures 90, and a plurality of Y+ side tab cooling structures (not shown). Each of the plurality of Y− side tab cooling structures 90 forms a portion of a Y− side tab cooling structure assembly 99. A refrigerant is supplied to the Y− side tab cooling structure assembly 99 from, for example, a refrigerant circuit 200 shown in FIGS. 8 and 9. Each of the plurality of Y+ side tab cooling structures (not shown) forms a portion of a Y+ side tab cooling structure assembly 99. The refrigerant is supplied to the Y+ side tab cooling structure assembly 99 from the refrigerant circuit 200.

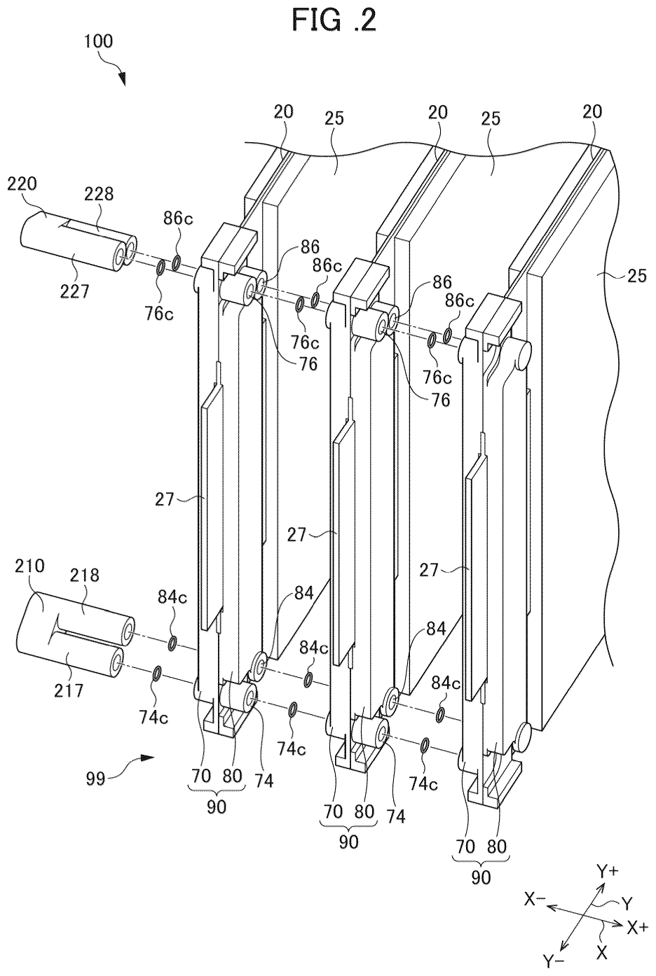

The following first describes the plurality of battery cells 20 shown in FIG. 1. The battery cells 20 are stacked in the X direction. Each of the battery cells 20 is a laminated all-solid-state battery. As shown in FIG. 2, each battery cell 20 has a cell body 25, a Y− side tab 27, and a Y+ side tab (not shown).

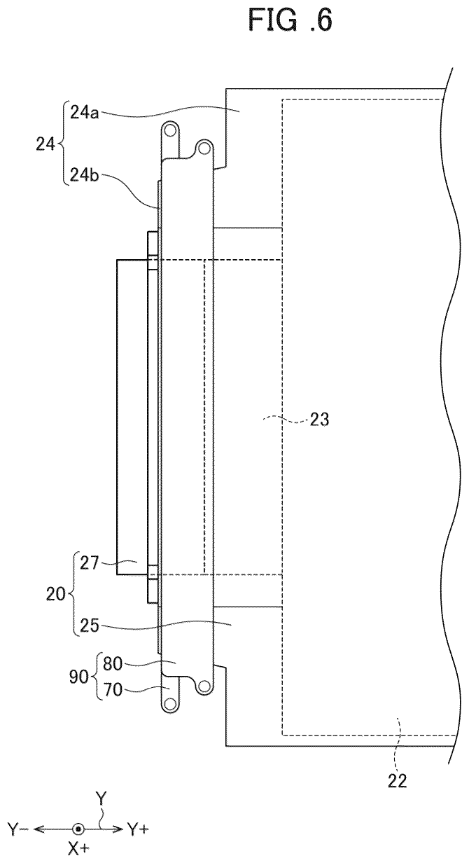

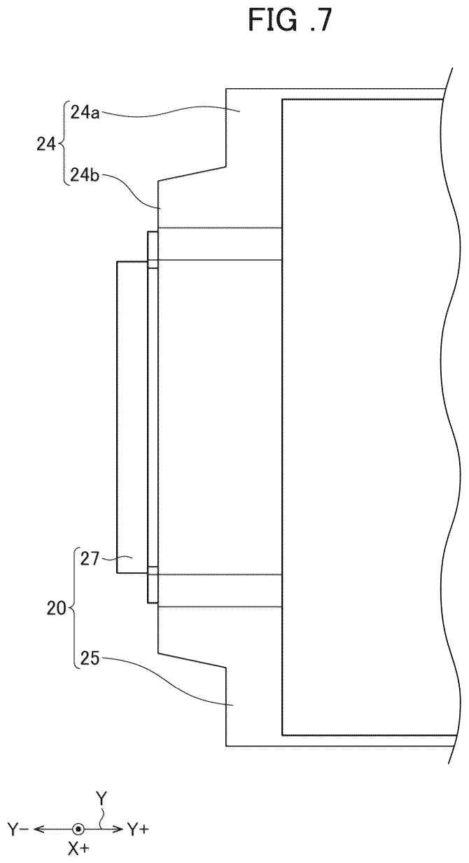

As shown in FIG. 7, the cell body 25 extends in the up-down direction and in the Y direction. As shown in FIG. 6, the cell body 25 includes a Y− side tab joint 23, an electrode body 22 on one side, a solid electrolyte layer (not shown), an electrode body on the other side (not shown), a Y+ side tab joint (not shown), and a laminate 24.

The electrode body 22 on the one side is one of a pair of positive and negative electrode bodies, and extends in the up-down direction and in the Y direction. The electrode body on the other side (not shown) is the other of the pair of positive and negative electrode bodies. The opposite electrode body is positioned further toward the X direction side than the electrode body 22, and extends in the up-down direction and in the Y direction. The solid electrolyte layer (not shown) is located between the electrode body 22 on the one side and the electrode body on the other side (not shown), and extends in the up-down direction and in the Y direction.

The Y− side tab 27 is a conductor extending in the up-down direction and protruding from the cell body 25 toward the Y− side. The Y+ side tab (not shown) is a conductor extending in the up-down direction and protruding from the cell body 25 toward the Y+ side.

The Y− side tab joint 23 is a conductor extending in the up-down direction, and electrically connects the Y− side tab 27 and the electrode body 22 on the one side. The Y+ side tab joint (not shown) is a conductor extending in the up-down direction, and electrically connects the Y+ side tab (not shown) and the electrode body on the other side (not shown). As such, either the Y− side tab 27 or the Y+ side tab (not shown) is a positive-electrode tab that serves as a positive electrode, and the other is a negative-electrode tab that serves as a negative electrode.

The laminate 24 shown in FIG. 6 is an insulator, and includes a main part 24a, a Y− side protrusion 24b protruding from the main part 24a toward the Y− side, and a Y+ side protrusion (not shown) protruding from the main part 24a toward the Y+ side. The main part 24a covers a Y+ side region of the Y− side tab joint 23, the electrode body 22 on the one side, the solid electrolyte layer (not shown), the electrode body on the other side (not shown), and a Y− side region of the Y+ side tab joint (not shown).

The Y− side protrusion 24b covers a Y+ side region of the Y− side tab 27 and a Y− side region of the Y− side tab joint 23. The Y+ side protrusion (not shown) covers a Y− side region of the Y+ side tab (not shown) and a Y+ side region of the Y+ side tab joint (not shown). As such, the Y− side tab 27 protrudes farther toward the Y− side than the Y− side protrusion 24b, and the Y+ side tab (not shown) protrudes farther toward the Y+ side than the Y+ side protrusion (not shown).

Intercell members 30 each including a cushioning material and a heat insulating material are disposed between the battery cells 20. The intercell members 30 may extend to lateral faces of the Y− side tabs 27 and the Y+ side tabs (not shown) to the extent that the intercell members 30 do not interfere with the Y− side tab cooling structures 90 and the Y+ side tab cooling structures (not shown) or may reside within the range of the lateral faces of the cell bodies 25.

The tab cooling structures 90 are attached to the respective tabs 27 of the battery cells 20 as shown in FIG. 1. Thereafter, outward ends of the tabs 27 of predetermined battery cells 20 located next to each other in the X direction are electrically connected together via bus bars 40.

The following describes the Y− side tab cooling structures 90 shown in FIG. 1. The Y− side tab cooling structures 90 are provided in on-to-one correspondence with the Y− side tabs 27.

As shown in FIG. 1, each of the Y− side tab cooling structures 90 includes a first unit 70 and a second unit 80. The first unit 70 and the second unit 80 are both made of an insulating material and extend in the up-down direction. The first unit 70 is positioned further toward the X− side than the tab 27 to be cooled, and the second unit 80 is positioned further toward the X+ side than the tab 27 to be cooled.

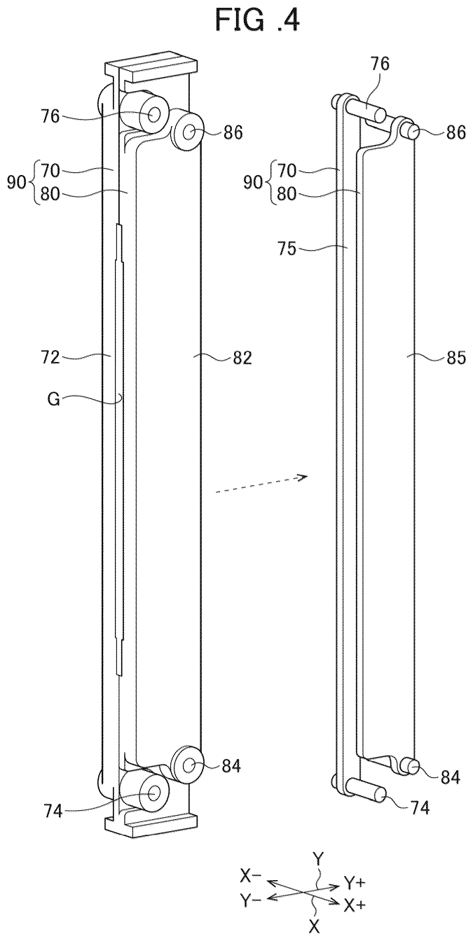

As shown in FIG. 4, the first unit 70 includes a first body 72, a first supply pipe 74, a first cooler 75, and a first discharge pipe 76. The first body 72 contains therein the first supply pipe 74, the first cooler 75, and the first discharge pipe 76. The first cooler 75 extends in the up-down direction in the first body 72 and is configured to allow the refrigerant to pass through the inside thereof.

The first supply pipe 74 is located near a lower end portion of the first cooler 75 and extends in the X direction. A middle portion of the first supply pipe 74 in the X direction is in communication with the lower end portion of the first cooler 75, so that the refrigerant is supplied into the first cooler 75. The first discharge pipe 76 is located near an upper end portion of the first cooler 75 and extends in the X direction. A middle portion of the first discharge pipe 76 in the X direction is in communication with the upper end portion of the first cooler 75, so that the refrigerant is discharged from the first cooler 75.

The second unit 80 includes a second body 82, a second supply pipe 84, a second cooler 85, and a second discharge pipe 86. The description of the first unit 70 given above also applies to the second unit 80, providing that “first” is replaced with “second”, and the reference numerals are replaced with corresponding ones.

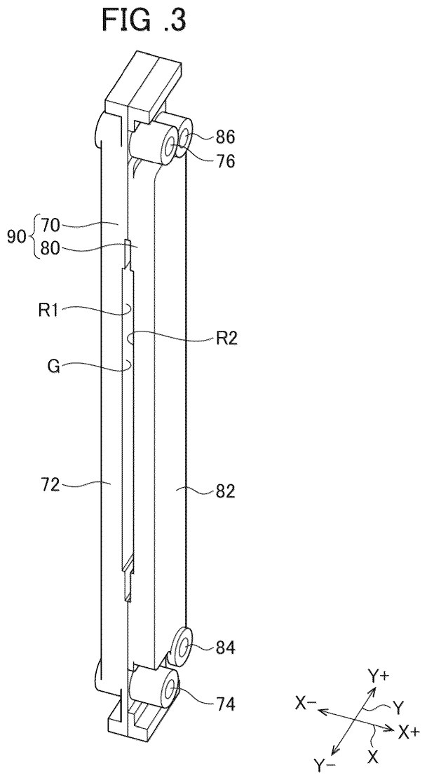

As shown in FIG. 3, an upper end portion of the first body 72 and an upper end portion of the second body 82 are connected together. A lower end portion of the first body 72 and a lower end portion of the second body 82 are connected together. An X+ side lateral face of a middle portion of the first body 72 in the up-down direction has a first recess R1 indented toward the X− side. An X− side lateral face of a middle portion of the second body 82 in the up-down direction has a second recess R2 indented toward the X+ side. Thus, the first recess R1 and the second recess R2 form a gap G between the first body 72 and the second body 82.

The first unit 70 and the second unit 80 are both flexible. Thus, the position of a middle portion of the first unit 70 in the up-down direction and the position of a middle portion of the second unit 80 in the up-down direction are shiftable relative to each other in the X direction. In this configuration, when the battery 100 is assembled, the tab 27 can be inserted into the gap by widening the gap G in the X direction. With the tab 27 positioned in the gap G, as shown in FIG. 6, the first cooler 75 and the second cooler 85 sandwich the protrusion 24b of the cell body 25 therebetween in the X direction. Thus, the first cooler 75 and the second cooler 85 sandwich a Y+ side portion of the Y− side tab 27 and a Y− side portion of the Y− side tab joint 23 therebetween in the X direction.

The following describes the Y+ side tab cooling structures (not shown). The description of the Y− side tab cooling structures 90 given above also applies to the Y+ side tab cooling structures (not shown), providing that “Y−” is replaced with “Y+”, “Y+” is replaced with “Y−”, and the reference numerals for the tab cooling structures and the components thereof are replaced with “(not shown)”.

The following describes the Y− side tab cooling structure assembly 99 shown in FIG. 1. In the Y− side tab cooling structure assembly 99, the Y− side tab cooling structures 90 located next to each other in the X direction are connected together.

Specifically, as shown in FIG. 2, first supply pipe connectors 74c, second supply pipe connectors 84c, first discharge pipe connectors 76c, and second discharge pipe connectors 86c are provided between the tab cooling structures 90 located next to each other in the X direction. The first supply pipe connectors 74c, the second supply pipe connectors 84c, the first discharge pipe connectors 76c, and the second discharge pipe connectors 86c each include an O-ring.

The first supply pipe connectors 74c connect the first supply pipes 74 located next to each other in the X direction. The second supply pipe connectors 84c connect the second supply pipes 84 located next to each other in the X direction. The first discharge pipe connectors 76c connect the first discharge pipes 76 located next to each other in the X direction. The second discharge pipe connectors 86c connect the second discharge pipes 86 located next to each other in the X direction. An X+ side end of the outermost first supply pipe 74 on the X+ side, an X+ side end of the outermost second supply pipe 84 on the X+ side, an X+ side end of the outermost first discharge pipe 76 on the X+ side, and an X+ side end of the outermost second discharge pipe 86 on the X+ side are closed.

A first supply portion 217 of a predetermined refrigerant supply pipe 210 is connected to the outermost first supply pipe 74 on the X− side. A second supply portion 218 of the refrigerant supply pipe 210 is connected to the outermost second supply pipe 84 on the X− side.

A first discharge portion 227 of a predetermined refrigerant discharge pipe 220 is connected to the outermost first discharge pipe 76 on the X− side. A second discharge portion 228 of the refrigerant discharge pipe 220 is connected to the outermost second discharge pipe 86 on the X− side.

The refrigerant is supplied from the first supply portion 217 to the first supply pipes 74 connected in sequence in the X direction. The refrigerant is supplied from the second supply portion 218 to the second supply pipes 84 connected in sequence in the X direction.

The refrigerant from the first discharge pipes 76 connected in sequence in the X direction is discharged to the first discharge portion 227. The refrigerant from the second discharge pipes 86 connected in sequence in the X direction is discharged to the second discharge portion 228.

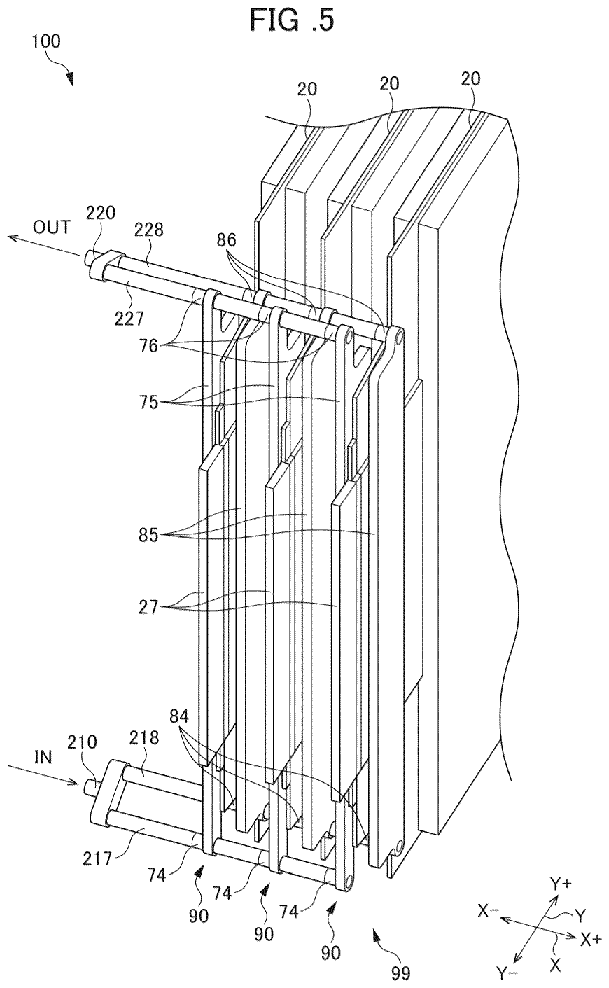

In this configuration, in each tab cooling structure 90 shown in FIG. 5, the refrigerant is supplied from the first supply pipe 74 to a lower portion of the first cooler 75, and is discharged from an upper portion of the first cooler 75 to the first discharge pipe 76. Thus, the refrigerant flows from bottom to top in the first cooler 75. Likewise, in each tab cooling structure 90, the refrigerant is supplied from the second supply pipe 84 to a lower portion of the second cooler 85, and is discharged from an upper portion of the second cooler 85 to the second discharge pipe 86. Thus, the refrigerant flows from bottom to top in the second cooler 85.

As described above, bottom-to-top refrigerant flows run in parallel in the first coolers 75 arranged in the X direction. Likewise, bottom-to-top refrigerant flows run in parallel in the second coolers 85 arranged in the X direction. Thus, the Y− side tab cooling structure assembly 99 cools the Y− side tabs 27 of the respective battery cells 20 arranged in the X direction using the respective Y− side tab cooling structures 90 arranged in the X direction.

The following describes the Y+ side tab cooling structure assembly 99 shown in FIGS. 8 and 9. The description of the Y− side tab cooling structure assembly 99 given above also applies to the Y+ side tab cooling structure assembly 99, providing that “Y−” is replaced with “Y+”, and the reference numerals for the components of the tab cooling structure assembly 99 are replaced with “(not shown)”.

The following describes the refrigerant circuit 200 shown in FIGS. 8 and 9. The refrigerant circuit 200 includes, for example, a tank 250, a pump 260, and a heat exchanger 270 as shown in FIG. 8. The refrigerant is stored in the tank 250. The pump 260 pressurizes the refrigerant and circulates the refrigerant between the tank 250, the Y− side tab cooling structure assembly 99, the Y+ side tab cooling structure assembly 99, and the heat exchanger 270. The refrigerant circuit 200 may be, for example, provided separately from a circuit 300 for supplying the refrigerant to a refrigerant path 101 under the battery 100 as shown in FIG. 8, or may be integral with the circuit for supplying the refrigerant to the refrigerant path 101 as shown in FIG. 9.

In FIGS. 8 and 9, the circuit 200 has a configuration for supplying the refrigerant to the Y− side tab cooling structure assembly 99 and the Y+ side tab cooling structure assembly 99 in parallel. However, the circuit 200 may alternatively have a configuration for supplying the refrigerant thereto in series. The circuit 200 shown in FIG. 9 has a configuration for supplying the refrigerant to the tab cooling structure assemblies 99 and the refrigerant path 101 under the battery 100 in parallel. However, the circuit 200 may have a configuration for supplying the refrigerant thereto in series.

The following is a summary of the configuration and effects of the present embodiment.

As shown in FIG. 5, the first cooler 75 is positioned further toward the X− side than the tab 27 to be cooled. The second cooler 85 is positioned further toward the X+ side than the tab 27 to be cooled. The refrigerant is supplied to the first cooler 75 through the first supply pipe 74. The refrigerant is supplied to the second cooler 85 through the second supply pipe 84. The refrigerant is discharged from the first cooler 75 through the first discharge pipe 76. The refrigerant is discharged from the second cooler 85 through the second discharge pipe 86. The first cooler 75 and the second cooler 85 sandwich the tab 27 to be cooled therebetween in the X direction. Thus, it is possible to cool the tab 27 using the first cooler 75 and the second cooler 85. The configuration described above therefore makes it possible to reduce an increase in the temperature of the tabs 27 in fast charging of the battery 100 and in discharging of the battery 100 during high-load driving. The configuration described above therefore makes it possible to prevent the temperature of the tabs 27 from serving as a rate-limiting factor in fast battery charging and in battery discharging during high-load driving. The configuration described above therefore makes it possible to apply high current, and to handle fast battery charging and battery discharging during high-load driving.

As shown in FIG. 6, the first cooler 75 and the second cooler 85 sandwich the protrusion 24b of the cell body 25 therebetween in the X direction, thereby sandwiching a portion of the tab joint 23 and a portion of the tab 27 therebetween in the X direction. Thus, it is possible to cool the tab joint 23 as well as the tab 27. The configuration described above therefore makes it possible to prevent the temperature of the tab joints 23, as well as the temperature of the tabs 27, from serving as a rate-limiting factor in fast battery charging and in battery discharging during high-load driving.

The first body 72 shown in FIG. 4 contains the first supply pipe 74, the first cooler 75, and the first discharge pipe 76. As such, the first body 72 allows the first supply pipe 74, the first cooler 75, and the first discharge pipe 76 to be integrated into a unitized structure. The second body 82 contains the second supply pipe 84, the second cooler 85, and the second discharge pipe 86. As such, the second body 82 allows the second supply pipe 84, the second cooler 85, and the second discharge pipe 86 to be integrated into a unitized structure. The configuration described above makes it possible to simplify the overall design of the tab cooling structure 90.

The middle portion of the first unit 70 in the up-down direction and the middle portion of the second unit 80 in the up-down direction shown in FIG. 3 are movable relative to each other in the X direction. Thus, it is possible to easily insert the tab 27 between the middle portion of the first unit 70 in the up-down direction and the middle portion of the second unit 80 in the up-down direction.

The refrigerant is supplied from the first supply pipe 74 shown in FIG. 5 to the lower portion of the first cooler 75, and is discharged from the upper portion of the first cooler 75 to the first discharge pipe 76, thereby flowing from bottom to top inside the first cooler 75. The configuration described above therefore makes it possible to discharge only excess refrigerant from the upper portion of the first cooler 75 while filling the first cooler 75 with the refrigerant from the lower portion. Such a mechanism makes it possible to prevent air from easily entering the first cooler 75. The same mechanism applies to the second cooler 85, making it possible to prevent air from easily entering the second cooler 85.

Each of the battery cells 20 shown in FIG. 1 is an all-solid-state battery having a solid electrolyte layer therein. The operating temperature range of all-solid-state batteries is relatively wide. In the configuration in which the battery cells 20 are all-solid-state batteries, therefore, the temperature of the tabs 27 easily reaches the limit of the allowable range thereof before the temperature of any part of the cell bodies 25 reaches the limit of the allowable range thereof. The temperature of the tabs 27 therefore tends to be a rate-limiting factor in fast battery charging and in battery discharging during high-load driving. The effect of reducing increase in the temperature of the tabs 27 in fast battery charging and in battery discharging during high-load driving produced by the present embodiment is therefore more significant in this configuration than in other configurations.

As shown in FIG. 1, each of the tab cooling structure assemblies 99 includes a plurality of tab cooling structures 90 arranged in the X direction. The tab cooling structures 90 located next to each other in the X direction are connected together. The plurality of tab cooling structures 90 can cool the respective tabs 27 of the plurality of battery cells 20. Furthermore, as a result of connecting the tab cooling structures 90 located next to each other in the X direction, it is possible to prevent each battery cell 20 from being displaced in the X direction.

As shown in FIG. 2, the first supply pipe connectors 74c connect the first supply pipes 74 in the tab cooling structures 90 located next to each other in the X direction. The second supply pipe connectors 84c connect the second supply pipes 84 in the tab cooling structures 90 located next to each other in the X direction. The first discharge pipe connectors 76c connect the first discharge pipes 76 in the tab cooling structures 90 located next to each other in the X direction. The second discharge pipe connectors 86c connect the second discharge pipes 86 in the tab cooling structures 90 located next to each other in the X direction.

As a result of connecting the first supply pipes 74 together as described above, it is possible to efficiently supply the refrigerant to each of the plurality of first coolers 75. Likewise, as a result of connecting the second supply pipes 84 together, it is possible to efficiently supply the refrigerant to each of the plurality of second coolers 75. As a result of connecting the first discharge pipes 76 together, it is possible to efficiently discharge the refrigerant from each of the plurality of first coolers 75. Likewise, as a result of connecting the second discharge pipes 86 together, it is possible to efficiently discharge the refrigerant from each of the plurality of second coolers 85. The configuration in which the pipes are connected as described above permits adjustment of the number of tab cooling structures 90 to be connected according to the number of battery cells 20 to be stacked, making it easy to accommodate differences in the number of cells to be stacked. The tab cooling structure assemblies 99 are therefore highly versatile.

### Second Embodiment

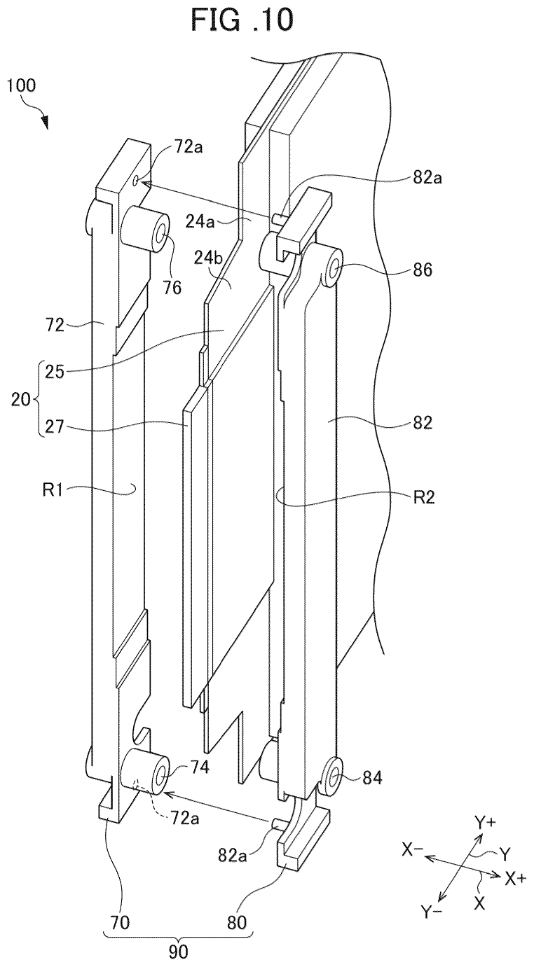

The following describes a second embodiment with reference to FIG. 10. The description of the present embodiment is based on the first embodiment and mainly focuses on differences from the first embodiment, omitting description of the same or similar features as those in the first embodiment as appropriate.

Each of the first bodies 72 has first engagement portions 72a formed in an upper end portion and a lower end portion of the X+ side lateral face thereof. Each of the second bodies 82 has second engagement portions 82a formed in an upper end portion and a lower end portion of the X− side lateral face thereof. In the present embodiment, the first engagement portions 72a are recesses and the second engagement portions 82a are projections. Conversely, the first engagement portions 72a may be projections and the second engagement portions 82a may be recesses.

The first unit 70 and the second unit 80 are engaged with each other through the engagement of the first engagement portions 72a and the second engagement portions 82a with each other. The tab 27 is placed between the first unit 70 and the second unit 80.

According to the present embodiment, it is possible to easily place the tab 27 between the first unit 70 and the second unit 80 by engaging the first engagement portions 72a and the second engagement portions 82a with each other.

### Other Embodiments

The embodiments described above may be, for example, modified as described below.

The battery cells 20 shown in FIG. 1 may be, for example, batteries other than all-solid-state batteries, such as semi-solid-state batteries or liquid lithium-ion batteries. In a case where only increase in the temperature of particular tabs 27 of the battery cells 20 is a concern, the tab cooling structures 90 may be provided only for these particular tabs 27.

Each of the foregoing embodiments may be implemented with the entire configuration rotated so that the direction referred to as the up-down direction in the embodiment is angled relative to the up-down direction. Furthermore, each of the foregoing embodiments may be implemented with the entire configuration rotated so that one of the directions referred to as the X direction and the Y direction in the embodiment is aligned with or angled relative to the up-down direction.

In a case where there is no need to integrate the first supply pipe 74, the first cooler 75, and the first discharge pipe 76 shown in FIG. 4 into a unitized structure, for example, the first body 72 may be omitted. Likewise, in a case where there is no need to integrate the second supply pipe 84, the second cooler 85, and the second discharge pipe 86 into a unitized structure, for example, the second body 82 may be omitted.

The refrigerant may flow inside the first coolers 75 and the second coolers 85 shown in FIG. 5 from top to bottom or in the horizontal direction, for example, as long as there is no particular problem with such a configuration. In a case where there is no particular need to cool the tab joint 23 shown in FIG. 6, for example, the first cooler 75 and the second cooler 85 may be configured to sandwich only the tab 27 therebetween in the X direction. The first cooler 75 and the second cooler 85 may be configured to sandwich the entire tab 27 and the entire tab joint 23 therebetween in the X direction.

### EXPLANATION OF REFERENCE NUMERALS

20: Battery cell
22: Electrode body
23: Tab joint
25: Cell body
27: Tab
40: Bus bar
70: First unit
72: First body
74: First supply pipe
74c: First supply pipe connector
75: First cooler
76: First discharge pipe
76c: First discharge pipe connector
80: Second unit
82: Second body
84: Second supply pipe
84c: Second supply pipe connector
85: Second cooler
86: Second discharge pipe
86c: Second discharge pipe connector
90: Tab cooling structure
99: Tab cooling structure assembly
100: Battery

What is claimed is:

1. A tab cooling structure for cooling a tab of one of battery cells stacked in a predetermined X direction, each of the battery cells including a cell body and the tab protruding from the cell body in a Y direction orthogonal to the X direction, the tab cooling structure comprising:
a first cooler that is positioned further toward one side in the X direction than the tab to be cooled;
a second cooler that is positioned further toward an opposite side in the X direction than the tab to be cooled;
a first supply pipe through which a refrigerant is supplied to the first cooler;
a second supply pipe through which the refrigerant is supplied to the second cooler;
a first discharge pipe through which the refrigerant is discharged from the first cooler; and
a second discharge pipe through which the refrigerant is discharged from the second cooler, wherein
the first cooler and the second cooler sandwich the tab to be cooled therebetween in the X direction.

2. The tab cooling structure according to claim 1, wherein
the first cooler and the second cooler sandwich a portion of the cell body therebetween in the X direction.

3. The tab cooling structure according to claim 2, wherein
the cell body includes, at an end thereof in the Y direction, a tab joint that electrically connects a predetermined electrode body and the tab, and a protrusion that covers at least a portion of the tab joint and a portion of the tab, the protrusion being an insulator, and
the first cooler and the second cooler sandwich the protrusion therebetween in the X direction, thereby sandwiching at least a portion of the tab joint and at least a portion of the tab therebetween in the X direction.

4. The tab cooling structure according to claim 1, comprising:
a first unit including a first body, the first supply pipe, the first cooler, and the first discharge pipe, the first body containing the first supply pipe, the first cooler, and the first discharge pipe; and
a second unit including a second body, the second supply pipe, the second cooler, and the second discharge pipe, the second body containing the second supply pipe, the second cooler, and the second discharge pipe.

5. The tab cooling structure according to claim 4, wherein
a lengthwise middle portion of the first unit and a lengthwise middle portion of the second unit are movable relative to each other in the X direction, and
the tab is inserted between the lengthwise middle portion of the first unit and the lengthwise middle portion of the second unit.

6. The tab cooling structure according to claim 4, wherein
the first body has a first engagement portion,
the second body has a second engagement portion,
the first unit and the second unit are engaged with each other through engagement of the first engagement portion and the second engagement portion with each other, and
the tab is placed between the first unit and the second unit.

7. The tab cooling structure according to claim 1, wherein
the refrigerant is supplied from the first supply pipe to a lower portion of the first cooler and is discharged from an upper portion of the first cooler to the first discharge pipe, thereby flowing from bottom to top inside the first cooler, and
the refrigerant is supplied from the second supply pipe to a lower portion of the second cooler and is discharged from an upper portion of the second cooler to the second discharge pipe, thereby flowing from bottom to top inside the second cooler.

8. The tab cooling structure according to claim 1, wherein
each of the battery cells is an all-solid-state battery having a solid electrolyte layer therein.

9. A tab cooling structure assembly comprising a plurality of the tab cooling structures according to claim 1, the tab cooling structures being arranged in the X direction, wherein
the tab cooling structures located next to each other in the X direction are connected together, and
the plurality of tab cooling structures cool the tabs of the battery cells.

10. The tab cooling structure assembly according to claim 9, further comprising:
one or more first supply pipe connectors that connect the first supply pipes in the tab cooling structures located next to each other in the X direction;
one or more second supply pipe connectors that connect the second supply pipes in the tab cooling structures located next to each other in the X direction;
one or more first discharge pipe connectors that connect the first discharge pipes in the tab cooling structures located next to each other in the X direction; and
one or more second discharge pipe connectors that connect the second discharge pipes in the tab cooling structures located next to each other in the X direction.
